(19) United States
(12) Patent Application Publication
(10) Pub. No.: US 2024/0430081 A1
(43) Pub. Date: Dec. 26, 2024

(54) DATA PROCESSING

(71) Applicant: Alipay (Hangzhou) Information Technology Co., Ltd., Hangzhou (CN)

(72) Inventors: Zhongtian Qian, Hangzhou (CN); Wuqiong Pan, Hangzhou (CN); Tao Wei, Hangzhou (CN); Tingting Li, Hangzhou (CN); Zhenqiang Wei, Hangzhou (CN); Tianyi Li, Hangzhou (CN)

(73) Assignee: Alipay (Hangzhou) Information Technology Co., Ltd., Hangzhou (CN)

(21) Appl. No.: 18/827,306

(22) Filed: Sep. 6, 2024

Related U.S. Application Data
(63) Continuation of application No. PCT/CN2023/071505, filed on Jan. 10, 2023.

(30) Foreign Application Priority Data
Mar. 8, 2022 (CN) 202210227401.5

(51) Int. Cl. H04L 9/08

(52) U.S. Cl. CPC H04L 9/0869; H04L 2209/46; H04L 2209/50

(57) ABSTRACT

Data processing methods, apparatuses, and computer-readable media are applied to a system including a data provider and N secure multi-party computation (MPC) computation parties. N is an integer greater than 3. In an example method, each MPC computation party obtains a first data component from a data message sent by the data provider. The first data component is a part of a plurality of data components obtained after the data provider splits private data, and the first data component is a logical component. Then, the first data component is converted from the logical component to an arithmetic component, to obtain a second data component, so as to perform MPC processing.

### CROSS-REFERENCE TO RELATED APPLICATIONS

This application is a continuation of PCT Application No. PCT/CN2023/071505, filed on Jan. 10, 2023, which claims priority to Chinese Patent Application No. 202210227401.5, filed on Mar. 8, 2022, and each application is hereby incorporated by reference in its entirety.

### TECHNICAL FIELD

One or more embodiments of this specification relate to the field of computer technologies, and in particular, to data processing methods and apparatuses.

### BACKGROUND

It is well known that, data usually include a large amount of privacy and confidential information, and are collectively referred to as private data. Many institutions such as enterprises and hospitals protect the private data. How to secretly share data over the Internet without disclosing privacy in cryptography is an important problem. In such a background, secure multi-party computation (MPC) emerges. MPC means that a group of participants who do not trust each other can perform collaborative computing while protecting privacy. The participant is referred to as an MPC computation party.

The data provider randomly splits the private data into a plurality of data components, and provides the data component to the MPC computation party through a secure channel established between the data provider and the MPC computation party. A principle in which the data provider provides a data component to each MPC computation party is that each MPC computation party obtains only a part of the data components rather than all of original data, and the original data can be restored after at least two MPC computation parties exchange the data component. Therefore, it can be ensured that each MPC computation party accesses only the data component. Even if an attacker breaks through an MPC computation party and steals or modifies it for a long time period, valid information cannot be obtained.

Because the data provider and the MPC computation party perform transmission through a public network, a data processing manner is urgently needed to reduce pressure placed by transmission of the data component between the data provider and the MPC computation party on transmission in the public network.

### SUMMARY

One or more embodiments of this specification describe a data processing method, to reduce pressure placed by transmission of a data component on transmission in a public network.

According to a first aspect, a data processing method is provided, applied to a system including a data provider and N secure multi-party computation (MPC) computation parties, where N is an integer greater than 3, and the method includes: obtaining, by each MPC computation party, a first data component from a data message sent by the data provider, where the first data component is a part of the plurality of data components obtained after the data provider splits private data, and the first data component is a logical component; and converting the first data component from the logical component to an arithmetic component, to obtain a second data component, so as to perform MPC processing.

According to some implementable manners of the embodiments of this application, the N MPC computation parties include a first MPC computation party, a second MPC computation party, and a third MPC computation party; and converting the logical component into the arithmetic component includes: Each MPC computation party performs zero-sharing processing, to obtain a third data component. The third data component is an arithmetic component. The first MPC computation party performs a first conversion and a second conversion on an arithmetic value by using a locally held logical component, to obtain two options. The two options are arithmetic components. The first MPC computation party performs an oblivious transfer to the third MPC computation party by using the two options. Each MPC computation party performs arithmetic sharing processing by using a locally obtained arithmetic component as to-be-shared data, to obtain the second data component.

According to some implementable manners of the embodiments of this application, the zero-sharing processing includes: Each MPC computation party generates a first derived value by using a locally held first zero-sharing key, and generates a second derived value by using a locally held second zero-sharing key; and obtains the third data component based on a difference between the first derived value and the second derived value.

According to some implementable manners of the embodiments of this application, the logical component includes a first logical component and a second logical component; that the first MPC computation party performs a first conversion and a second conversion on an arithmetic value by using a locally held logical component includes: The first MPC computation party generates a random value by using an interaction key; and performs the first conversion and the second conversion by using the first logical component and the second logical component that are locally held, the random value, and a quantity of decimal places of a fixed-point number used for the MPC processing, to obtain the two options; and the method further includes: The second MPC computation party generates the random value by using the interaction key.

According to some implementable manners of the embodiments of this application, the first conversion and the second conversion are respectively performed based on the following formulas, to obtain options m0 and m1:

$$m 0 = ( 0 \hat{} u 1 \hat{} u 2 ) \times ( 1 ≪ B ) - rnd ;$$

$$and$$

$$m 1 = ( 1 \hat{} u 1 \hat{} u 2 ) \times ( 1 ≪ B ) - rnd .$$

Here, \hat{ } is an exclusive OR operator; <<is a left-moving operator; u1 and u2 are respectively the first logical component and the second logical component; rnd is the random value; and B is the quantity of decimal places of the fixed-point number used for the MPC processing.

According to some implementable manners of the embodiments of this application, that each MPC computation party performs arithmetic sharing processing by using a locally obtained arithmetic component, to obtain the second data component includes: Each MPC computation party shares local to-be-shared data with a next MPC computation party after encrypting the local to-be-shared data, and receives and decrypts data shared by a previous MPC computation party. The decrypted data and the local to-be-shared data are combined, to obtain the second data component. Each MPC computation party performs the sharing processing in a cyclic order.

According to a second aspect, a data processing method is provided, applied to a system including a data provider and N MPC computation parties, where N is an integer greater than 3, and the method includes: The data provider splits private data into a plurality of data components; and distributes the plurality of data components to the N MPC computation parties by using a data message, so that each MPC computation party receives a part of the plurality of data components, and uses the part of data components as a first data component. The first data component is a logical component.

According to some implementable manners of the embodiments of this application, the plurality of data components are N data components; and the distributing the plurality of data components to the N MPC computation parties by using a data message includes: sending two data components to each MPC computation party, where the 1^{st} data component sent to any MPC computation party is the same as the 2^{nd} data component sent to a previous MPC computation party of the MPC computation party; and the MPC computation parties are sorted circularly.

According to a third aspect, a data processing apparatus is provided, applied to a system including a data provider and N secure multi-party computation (MPC) computation parties, where N is an integer greater than 3, and the apparatus is disposed on the MPC computation party, and includes: a data obtaining unit, configured to obtain a first data component from the data provider, where the first data component is a part of the plurality of data components obtained after the data provider splits private data, and the first data component is a logical component; and an arithmetic conversion unit, configured to convert the first data component from the logical component to an arithmetic component, to obtain a second data component, so as to perform MPC processing.

According to a fourth aspect, a data processing apparatus is provided, applied to a system including a data provider and N secure multi-party computation (MPC) computation parties, where N is an integer greater than 3, and the apparatus is disposed on the data provider, and includes: a data splitting unit, configured to split private data into a plurality of data components; and a data sending unit, configured to distribute the plurality of data components to the N MPC computation parties by using a data message, so that each MPC computation party receives a part of the plurality of data components, and uses the part of data components as a first data component, where the first data component is a logical component.

According to a fifth aspect, a computing device is provided, including a memory and a processor. The memory stores executable code, and when executing the executable code, the processor implements the method in the first aspect or the second aspect.

According to the methods and apparatuses provided in the embodiments of this specification, the data provider only needs to transmit a logical component to each MPC computation party; and each MPC computation party converts the received logical component into an arithmetic component, to reduce a data amount transmitted through a public network.

### BRIEF DESCRIPTION OF DRAWINGS

To describe the technical solutions in the embodiments of this application or in the existing technology more clearly, the following briefly describes the accompanying drawings needed for describing the embodiments or the existing technology. Clearly, the accompanying drawings in the following description show some embodiments of this application, and a person of ordinary skill in the art can still derive other drawings from these accompanying drawings without creative efforts.

FIG. 1 is an architectural diagram illustrating a system to which some embodiments of this application are applicable;

FIG. 2 is a flowchart illustrating a data processing method, according to some embodiments;

FIG. 3 is a flowchart illustrating a data processing method, according to some other embodiments;

FIG. 4 is an example diagram illustrating data transmission, according to some embodiments of this application;

FIG. 5 is an example diagram illustrating other data transmission, according to some embodiments of this application;

FIG. 6 is a flowchart illustrating a method for converting a logical component into an arithmetic component, according to some embodiments of this application;

FIG. 7 is a schematic block diagram illustrating a data processing apparatus, according to some embodiments; and

FIG. 8 is a schematic block diagram illustrating a data processing apparatus, according to some other embodiments.

### DESCRIPTION OF EMBODIMENTS

The terms used in the embodiments of this application are merely used to describe specific embodiments, and are not intended to limit this application. The terms “a”, “said”, and “the” of singular forms used in the embodiments of this application and the appended claims are also intended to include plural forms, unless otherwise specified in the context clearly.

It should be understood that the term “and/or” used in this specification merely describes an association relationship between associated objects and indicates that three relationships can exist. For example, A and/or B can indicate the following three cases: Only A exists, both A and B exist, and only B exists. In addition, the character “/” in this specification usually indicates an “or” relationship between the associated objects.

Depending on the context, for example, the word “if” used here can be interpreted as “while”, “when”, “in response to determining”, or “in response to detecting”. Similarly, depending on the context, the phrase “if determining . . . ” or “if detecting (the condition or event stated)” can be explained as “when determining . . . ”, “in response to determining . . . ”, “when detecting (the condition or event stated)”, or “in response to detecting (the condition or event stated)”.

FIG. 1 is an architectural diagram illustrating a system to which some embodiments of this application are applicable. As shown in FIG. 1, the system includes a data provider and N MPC computation parties. N is an integer greater than 3, and that N is 3 is used as an example in FIG. 1. Trusted-environment-based cryptographic computing (TECC) is based on a secure multi-party computation (MPC) algorithm, and is a secure and efficient cryptographic computing method. In a TECC application scenario, the MPC computation party can be each trusted execution environment (TEE).

Currently, in an existing data component transmission manner, a data provider and an MPC computation party perform transmission in a public network. In this transmission manner, each data provider needs to transmit (N-1)*N data components.

FIG. 1 is used as an example. A data provider 1 splits data u into u1, u2, and u3; and then, provides u1 and u2 to an MPC computation party A, provides u2 and u3 to an MPC computation party B, and provides u3 and u1 to an MPC computation party C.

In a model training or prediction scenario such as machine learning, private data provided by a data provider are one-hot encoded data of sample feature data. Correspondingly, a first data component transmitted by the data provider is a logical component into which the one-hot encoded data are split, and an arithmetic component corresponding to the logical component is transmitted because of a requirement of some application scenarios. The logical component is a data component whose element is a binary value, and the arithmetic component is a data component whose element is an integral data value. For example, for a data set whose feature quantity is d, whose bin is b, and whose sample quantity is n, X [d] [b] [n] can be used to represent one-hot encoding of sample feature data, and a value of each element of X [d] [b] [n] is 0 or 1. Each element occupies 1 bit, and is split into logical components. A size of each logical component is the same as that of X [d] [b] [n]. In addition, the data provider needs to provide a data component corresponding to the logical component. In other words, each element of X [d] [b] [n] is represented by an integer, and occupies 32 bits. In this manner, excessive transmission pressure is also clearly placed on a public network. That d=200, b=13, and n=100w is used as an example. It is difficult to accept that a size of six data components in full sending is approximately 60 GB. In this application, on a basis that a data amount transmitted through the public network is reduced, it is still ensured that each MPC computation party can obtain a logical component and a corresponding arithmetic component.

Solutions provided in this specification are described below with reference to the accompanying drawings.

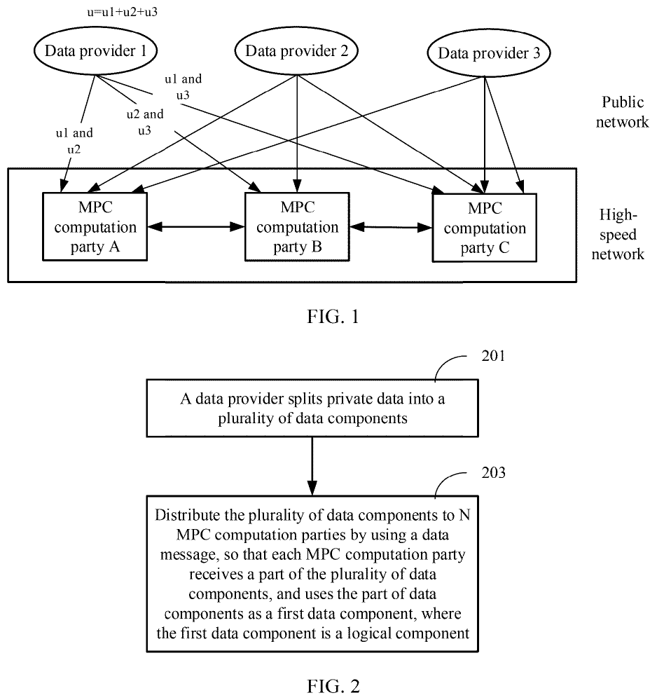

FIG. 2 is a flowchart illustrating a data processing method, according to some embodiments. The method is performed by a data provider in the system shown in FIG. 1. As shown in FIG. 2, the method includes the following steps: Step 201: The data provider splits private data into a plurality of data components.

Step 203: Distribute the plurality of data components to N MPC computation parties by using a data message, so that each MPC computation party receives a part of the plurality of data components, and uses the part of data components as a first data component, where the first data component is a logical component.

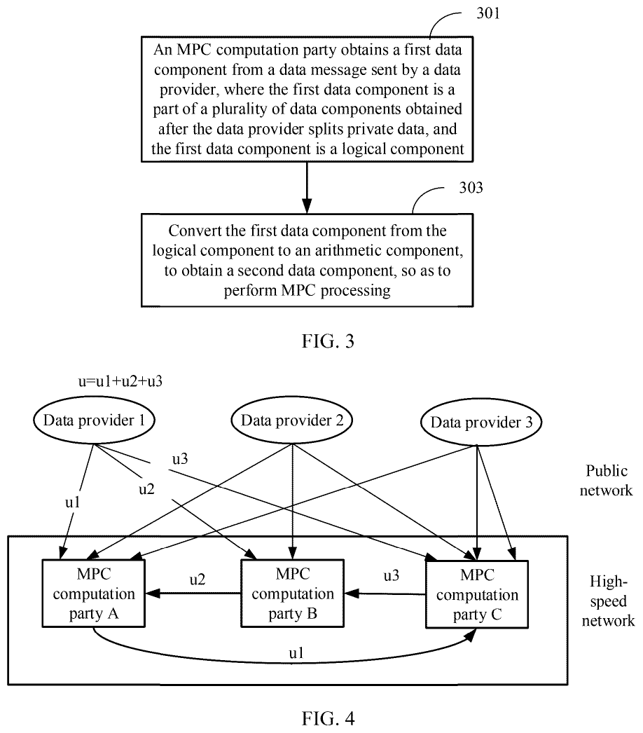

FIG. 3 is a flowchart illustrating a data processing method, according to some other embodiments. The method is performed by each MPC computation party in the system shown in FIG. 1. As shown in FIG. 3, the method includes the following steps.

Step 301: The MPC computation party obtains a first data component from a data message sent by a data provider, where the first data component is a part of a plurality of data components obtained after the data provider splits private data, and the first data component is a logical component.

Step 303: Convert the first data component from the logical component to an arithmetic component, to obtain a second data component, so as to perform MPC processing.

According to the data processing methods shown in FIG. 2 and FIG. 3, the data provider transmits only the logical component instead of transmitting the logical component and the arithmetic component that originally need to be both transmitted to the MPC computation party. Each MPC computation party converts a received logical component into an arithmetic component, to reduce a data amount transmitted through a public network.

In some implementable manners, the data provider can still split the private data into the plurality of data components in an existing transmission manner. Then, two data components are sent to each MPC computation party. The 1^{st} data component sent to any MPC computation party is the same as the 2^{nd} data component sent to a previous MPC computation party of the MPC computation party.

FIG. 1 is used as an example. A data provider 1 splits data u into u1, u2, and u3; and then, provides u1 and u2 to an MPC computation party A, provides u2 and u3 to an MPC computation party B, and provides u3 and u1 to an MPC computation party C. In other words, in step 301, a first data component obtained by the MPC computation party A is u1 and u2. Because both u1 and u2 are logical components, u1 and u2 are respectively referred to as a first logical component and a second logical component. Correspondingly, a first logical component and a second logical component that are included in a first data component obtained by the MPC computation party B are respectively u2 and u3, and a first logical component and a second logical component that are included in a first data component obtained by the MPC computation party C are respectively u3 and u1.

In some other implementable manners, the data provider can respectively send N data components to N MPC computation parties. In other words, each MPC computation party receives one of the data components, and each MPC computation party receives a different data component.

In this case, in step 301, after receiving the data component, the MPC computation party can obtain the first data component by performing arithmetic sharing processing by using the received data component.

The arithmetic sharing processing is: sharing local to-be-shared data with a next MPC computation party after encrypting the local to-be-shared data, and receiving and decrypting data shared by a previous MPC computation party. Then, the received decrypted data and the local to-be-shared data are combined, to obtain the first data component. In other words, the arithmetic sharing processing is a process in which each MPC computation party performs data sharing in a cyclic order. In addition, a key used when the MPC computation party performs encryption is the same as a key used when the next MPC computation party performs decryption. The key is preconfigured or pre-agreed upon.

This implementation is described by using the three MPC computation parties shown in FIG. 1 as an example. As shown in FIG. 4, the data provider still splits original data into three data components u1, u2, and u3; and then, transmits u1 to the MPC computation party A, transmits u2 to the MPC computation party B, and transmits u3 to the MPC computation party C.

The MPC computation party A, the MPC computation party B, and the MPC computation party C jointly perform one time of arithmetic sharing processing. All MPC computation parties pre-agree upon an interaction key, so that each MPC computation party locally has an interaction key pair (share_rng_d, share_rng_u). share_rng_d of the MPC computation party A is the same as share_rng_u of the MPC computation party C, share_rng_d of the MPC computation party B is the same as share_rng_u of the MPC computation party A, and share_rng_d of the MPC computation party C is the same as share_rng_u of the MPC computation party B.

During arithmetic sharing processing, the MPC computation party A encrypts u1 by using share_rng_d, and then transmits the encrypted u1 to the MPC computation party C. The MPC computation party C decrypts the encrypted u1 by using share_rng_u, to obtain u1.

The MPC computation party B encrypts u2 by using share_rng_d, and then transmits the encrypted u2 to the MPC computation party A. The MPC computation party A decrypts the encrypted u2 by using share_rng_u, to obtain u2.

The MPC computation party C encrypts u3 by using share_rng_d, and then transmits the encrypted u3 to the MPC computation party B. The MPC computation party B decrypts the encrypted u3 by using share_rng_u, to obtain u3.

After arithmetic sharing processing, the MPC computation party A locally has u1 and u2, the MPC computation party B locally has u2 and u3, and the MPC computation party C locally has u3 and u1. However, only three data components (logical components) need to be transmitted in the public network. In other words, six data components that originally need to be transmitted are reduced to three data components. However, when MPC computation parties perform arithmetic sharing, pressure placed on transmission in a network is very small because arithmetic sharing is performed in a high-speed network.

In still some other implementable manners, a quantity of data components obtained by the data provider through splitting is less than N, only one data component is transmitted to a part of the MPC computation parties, and the other MPC obtains zero data components. In other words, some MPC computation parties each receive one of the data components, each MPC computation party receives a different data component, and the other MPC computation parties receive zero data components.

In this case, in step 301, after obtaining the data component (1 or 0 data components) from the data message, the MPC computation party can perform zero-sharing processing, to obtain a fourth data component; combine the obtained fourth data component and the data component obtained from the data message, to obtain a fifth data component; and perform arithmetic sharing processing by using the fifth data component as the to-be-shared data, to obtain the first data component.

Zero-sharing processing means that each MPC computation party independently generates a data component, and the sum of data components generated by all MPC computation parties is 0. Specifically, the zero-sharing processing includes: The MPC computation party generates a first derived value by using a locally held first zero-sharing key, and generates a second derived value by using a locally held second zero-sharing key; and obtains the fourth data component based on a difference between the first derived value and the second derived value. All the MPC computation parties pre-agree upon a zero-sharing key, so that each MPC computation party locally has a key pair (prng, prngu) including a first zero-sharing key and a second zero-sharing key. prng of the MPC computation party A is the same as prngu of the MPC computation party C, prng of the MPC computation party B is the same as prngu of the MPC computation party A, and prng of the MPC computation party C is the same as prngu of the MPC computation party B.

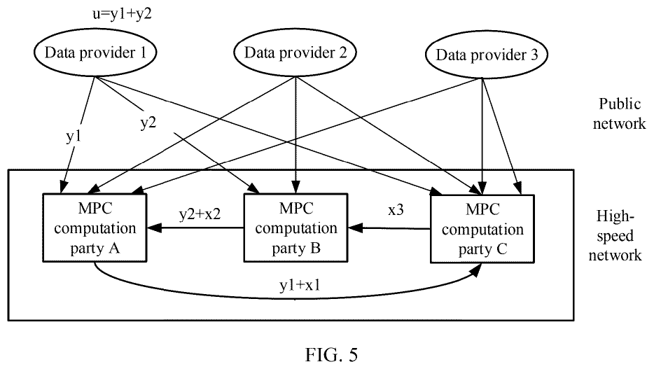

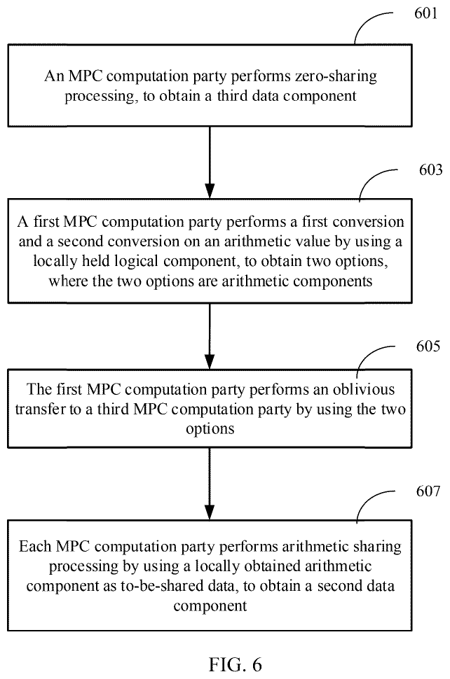

This implementation is described by using the three MPC computation parties shown in FIG. 1 as an example. As shown in FIG. 5, the data provider still splits original data into two data components y1 and y2; and then, transmits y1 to the MPC computation party A, and transmits y2 to the MPC computation party B. The MPC computation party C obtains zero data components.

The MPC computation party A, the MPC computation party B, and the MPC computation party C jointly perform one time of zero-sharing processing, to respectively obtain three components x1, x2, and x3 of 0. Specifically, each MPC computation party generates a first derived value buf1 by using prng, generates a second derived value buf2 by using prngu, and uses a value of buf1-buf2 as the fourth data component obtained through zero-sharing processing.

The MPC computation party A combines results x1 and y1 of zero-sharing processing, to obtain a fifth data component x1+y1; the MPC computation party B combines results x2 and y2 of zero-sharing processing, to obtain a fifth data component x2+y2; and the MPC computation party C combines a result x3 of zero-sharing processing and the received zero data components, to obtain a fifth data component x3.

Then, the MPC computation party A, the MPC computation party B, and the MPC computation party C jointly perform one time of arithmetic sharing processing.

During arithmetic sharing processing, the MPC computation party A encrypts x1+y1 by using share_rng_d, and then transmits the encrypted x1+y1 to the MPC computation party C. The MPC computation party C decrypts the encrypted x1+y1 by using share_rng_u, to obtain x1+y1.

The MPC computation party B encrypts x2+y2 by using share_rng_d, and then transmits the encrypted x2+y2 to the MPC computation party A. The MPC computation party A decrypts the encrypted x2+y2 by using share_rng_u, to obtain x2+y2.

The MPC computation party C encrypts x3 by using share_rng_d, and then transmits the encrypted x3 to the MPC computation party B. The MPC computation party B decrypts the encrypted x3 by using share_rng_u, to obtain x3.

After arithmetic sharing processing, the MPC computation party A locally has u1=x1+y1 and u2=x2+y2, the MPC computation party B locally has u2=x2+y2 and u3=x3, and the MPC computation party C locally has u3=x3 and u1=x1+y1. However, only two data components need to be transmitted in the public network. In other words, six data components that originally need to be transmitted are reduced to two data components. However, when MPC computation parties perform arithmetic sharing, pressure placed on transmission in a network is very small because arithmetic sharing is performed in a high-speed network.

A quantity of data components (logical components) can be reduced from 6 to 3 or 2 in the manner described in the above-mentioned embodiments.

Step 303 of “converting the first data component from the logical component to an arithmetic component, to obtain a second data component, so as to perform MPC processing” is described in detail below with reference to some embodiments.

FIG. 6 is a flowchart illustrating a method for converting a logical component into an arithmetic component, according to some embodiments of this application. In such a procedure, a system includes a first MPC computation party, a second MPC computation party, and a third MPC computation party. As shown in FIG. 6, the method includes the following steps: Step 601: Each MPC computation party performs zero-sharing processing, to obtain a third data component.

During zero-sharing processing, each MPC computation party generates the first derived value by using the locally held first zero-sharing key, and generates the second derived value by using the locally held second zero-sharing key; and obtains the third data component based on the difference between first derived value and the second derived value. The third data component obtained through zero-sharing processing is an arithmetic component. Details are described by using an example in the following embodiments.

Step 603: The first MPC computation party performs a first conversion and a second conversion on an arithmetic value by using a locally held logical component, to obtain two options, where the two options are arithmetic components.

In some implementable manners, the first MPC computation party can generate a random value by using an interaction key; and perform the first conversion and the second conversion by using a first logical component and a second logical component that are locally held, the random value, and a quantity of decimal places of a used fixed-point number, to obtain the two options. In addition, the second MPC computation party can also generate the random value by using the interaction key.

The two options m0 and m1 can be respectively obtained based on the following formulas:

$$m 0 = ( 0 \hat{} u 1 \hat{} u 2 ) \times ( 1 ≪ B ) - rnd ;$$

$$and$$

$$m 1 = ( 1 \hat{} u 1 \hat{} u 2 ) \times ( 1 ≪ B ) - rnd .$$

Here, \hat{ } is an exclusive OR operator, <<is a left-moving operator, and B is the quantity of decimal places of the fixed-point number used for the MPC processing. The fixed-point number is used in an MPC algorithm, and the fixed-point number is usually a fixed-point decimal. Most of numeric data processed by a computer are decimals, and a decimal point is usually implied at a fixed location. This is referred to as a fixed-point representation, and is briefly referred to as a fixed-point number. rnd is the random value, and can be generated by using a locally held interaction key share_rng_u.

Step 605: The first MPC computation party performs an oblivious transfer to the third MPC computation party by using the two options.

The oblivious transfer (OT) is a cryptographic protocol, and is currently widely applied to MPC. A purpose is that an MPC computation party sends m0 and m1 to another MPC computation party, and the another MPC computation party can only obtain one of m0 and m1. The MPC computation party that sends m0 and m1 cannot learn of which of m0 and m1 is obtained by the another MPC computation party.

In some implementable manners, the oblivious transfer in this step can be an oblivious transfer among three parties. The first MPC computation party serves as a sending party, the second MPC computation party serves as a helping party, and the third MPC computation party serves as a receiving party. The first MPC computation party performs one oblivious transfer by using m0 and m1 as two options and using, as an option, u3 locally held by the second MPC computation party and the third MPC computation party. Details are described by using an example in the following embodiments.

Step 607: Each MPC computation party performs arithmetic sharing processing by using a locally obtained arithmetic component as to-be-shared data, to obtain the second data component.

Specifically, during arithmetic sharing processing, each MPC computation party shares local to-be-shared data with a next MPC computation party after encrypting the local to-be-shared data, and receives and decrypts data shared by a previous MPC computation party. The decrypted data and the local to-be-shared data are combined, to obtain the second data component. Each MPC computation party performs the sharing processing in a cyclic order.

This implementation is described by using the three MPC computation parties shown in FIG. 1 as an example. It is assumed that the MPC computation party A, the MPC computation party B, and the MPC computation party C respectively obtain first data components (u1, u2), (u2, u3), and (u3, u1).

The MPC computation party A, the MPC computation party B, and the MPC computation party C jointly perform one time of zero-sharing processing, to respectively obtain respective third data components r1, r2, and r3. Here, r1, r2, and r3 are all arithmetic components.

The MPC computation party A generates a random value rnd by using the local share_rng_u, and determines

$$m 0 = ( 0 \hat{} u 1 \hat{} u 2 ) \times ( 1 ≪ B ) - rnd ;$$

$$and$$

$$m 1 = ( 1 \hat{} u 1 \hat{} u 2 ) \times ( 1 ≪ B ) - rnd .$$

Here, “1<<B” is arithmetic component conversion processing. In other words, (1\hat{ }x.b\hat{ }x.bu) is converted into an arithmetic value.

The MPC computation party B generates a random value rnd by using the local share_rng_d, and the value is the same as the random value generated by the MPC computation party A. In this case, the MPC computation party B locally holds r2′. Here, r2′=r2+rnd.

The MPC computation party A serves as a sending party of the oblivious transfer, the MPC computation party B serves as a helping party, and the MPC computation party C serves as a receiving party. The MPC computation party A performs one oblivious transfer by using m0 and m1 as two options and using, as an option, u3 locally held by the MPC computation party B and the MPC computation party C.

Specifically, the MPC computation party A and the MPC computation party B interact to generate common random values W0 and W1. The MPC computation party A sends m0\hat{ }W0 and m1\hat{ }W1 to the MPC computation party C. The MPC computation party B sends Wc to the MPC computation party C by using u3. Here, Wc is W0 or W1. The MPC computation party C decrypts each of m0\hat{ }W0 and m1\hat{ }W1 by using Wc, and decrypts one of m0\hat{ }W0 and m1\hat{ }W1, to obtain mi. Here, mi is a value in m0 and m1. After the oblivious transfer, the MPC computation party C locally holds r3′. Here, r3′=r3+mi.

The MPC computation party A uses r1 as to-be-shared data, the MPC computation party B uses r2′ as to-be-shared data, and the MPC computation party C uses r3′ as to-be-shared data, to perform one time of arithmetic sharing processing, so as to obtain respective arithmetic components. In other words, the MPC computation party A obtains an arithmetic component r1+r2′, the MPC computation party B obtains an arithmetic component r2+r3′, and the MPC computation party C obtains an arithmetic component r1+r3′.

The following demonstrates whether an arithmetic component is obtained in the above-mentioned process: Because a value of u3 is 0 or 1:
when u3 is 0:

$$r 1 + r {2}^{′} + r {3}^{′} = r 1 + r 2 + rnd + r 3 + ( 0 \hat{} u 1 \hat{} u 2 ) * ( 1 ≪ B ) - rnd = ( 0 \hat{} u 1 \hat{} u 2 ) * ( 1 ≪ B ) = ( u 3 \hat{} u 1 \hat{} u 2 ) * ( 1 ≪ B ) ;$$

$$or$$

when u3 is 1:

$$r 1 + r {2}^{′} + r {3}^{′} = r 1 + r 2 + rnd + r 3 + ( 1 \hat{} u 1 \hat{} u 2 ) * ( 1 ≪ B ) - rnd = ( 1 \hat{} u 1 \hat{} u 2 ) * ( 1 ≪ B ) = ( u 3 \hat{} u 1 \hat{} u 2 ) * ( 1 ≪ B ) .$$

Here, (1<<B) is actually processing of converting a logical value into an arithmetic value. To be specific, r1+r2′+r3′ is equivalent to the sum of logical quantities, and (u3\hat{ }u1\hat{ }u2) is converted into an arithmetic value. One time of arithmetic sharing is performed on r1, r2′, and r3′, and the three MPC computation parties each have an arithmetic component.

In this example, the data provider only needs to send a logical component of a sample, but does not need to send an arithmetic component. Compared with a case in which the logical component and the arithmetic component both need to be transmitted, in this example, a data transmission amount is reduced to 1/33.

Specific embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular sequence or consecutive sequence to achieve the desired results. In some implementations, multi-tasking and parallel processing are feasible or may be advantageous.

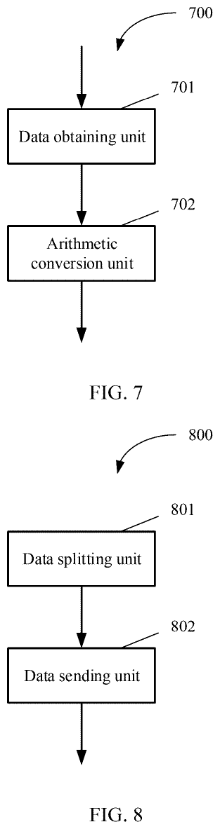

According to some embodiments of another aspect, a data processing apparatus is provided. FIG. 7 is a schematic block diagram illustrating a data processing apparatus, according to some embodiments. It can be understood that the apparatus can be disposed on an MPC computation party in the system shown in FIG. 1, and can be embodied in a form of an application or a functional unit such as a plug-in or a software development kit (SDK) in the application program. As shown in FIG. 7, the apparatus 700 includes a data obtaining unit 701 and an arithmetic conversion unit 702. Main functions of all constitutional units are as follows: The data obtaining unit 701 is configured to obtain a first data component from a data provider. The first data component is a part of a plurality of data components obtained after the data provider splits private data, and the first data component is a logical component.

The arithmetic conversion unit 702 is configured to convert the first data component from the logical component to an arithmetic component, to obtain a second data component, so as to perform MPC processing.

In some implementable manners, the arithmetic conversion unit 702 can be specifically configured to perform zero-sharing processing, to obtain a third data component. The third data component is an arithmetic component. If the apparatus is located on a first MPC computation party, the arithmetic conversion unit 702 performs a first conversion and a second conversion on an arithmetic value by using a locally held logical component, to obtain two options. The two options are arithmetic components. An oblivious transfer is performed to a third MPC computation party by using the two options.

If the apparatus is located on the third MPC computation party, the arithmetic conversion unit 702 obtains an option obliviously transferred by the first MPC computation party.

The arithmetic conversion unit 702 is further configured to perform arithmetic sharing processing by using a locally obtained arithmetic component as to-be-shared data, to obtain the second data component.

In some implementable manners, during zero-sharing processing, the arithmetic conversion unit 702 can generate a first derived value by using a locally held first zero-sharing key, and generate a second derived value by using a locally held second zero-sharing key; and obtain the third data component based on a difference between first derived value and the second derived value.

In some implementable manners, when performing the first conversion and the second conversion on the arithmetic value by using the locally held logical component, the arithmetic conversion unit 702 can specifically generate a random value by using an interaction key; and perform the first conversion and the second conversion by using a first logical component and a second logical component that are locally held, the random value, and a quantity of decimal places of a used fixed-point number, to obtain the two options.

If the apparatus is located on a second MPC computation party, the arithmetic conversion unit 702 also generates the random value by using the interaction key.

The first conversion and the second conversion are respectively performed based on the following formulas, to obtain the options m0 and m1:

$$m 0 = ( 0 \hat{} u 1 \hat{} u 2 ) \times ( 1 ≪ B ) - rnd ;$$

$$and$$

$$m 1 = ( 1 \hat{} u 1 \hat{} u 2 ) \times ( 1 ≪ B ) - rnd .$$

Here, \hat{ } is an exclusive OR operator; <<is a left-moving operator; u1 and u2 are respectively the first logical component and the second logical component; rnd is random value; and B is the quantity of decimal places of the used fixed-point number.

In some implementable manners, when performing arithmetic sharing processing by using the locally obtained arithmetic component, the arithmetic conversion unit 702 can specifically share local to-be-shared data with a next MPC computation party after encrypting the local to-be-shared data, and receive and decrypt data shared by a previous MPC computation party. The decrypted data and the local to-be-shared data are combined, to obtain the second data component. Each MPC computation party performs the sharing processing in a cyclic order.

According to some embodiments of another aspect, a data processing apparatus is provided. FIG. 8 is a schematic block diagram illustrating a data processing apparatus, according to some embodiments. It can be understood that the apparatus can be disposed on a data provider in the system shown in FIG. 1, and can be embodied in a form of an application or a functional unit such as a plug-in or a software development kit (SDK) in the application program. As shown in FIG. 8, the apparatus 800 includes a data splitting unit 801 and a data sending unit 802. Main functions of all constitutional units are as follows: The data splitting unit 801 is configured to split private data into a plurality of data components.

The data sending unit 802 is configured to distribute the plurality of data components to N MPC computation parties by using a data message, so that each MPC computation party receives a part of the plurality of data components, and uses the part of data components as a first data component. The first data component is a logical component.

In some implementable manners, the plurality of data components are N data components. The data sending unit 802 can send two data components to each MPC computation party. The 1^{st} data component sent to any MPC computation party is the same as the 2^{nd} data component sent to a previous MPC computation party of the MPC computation party. The MPC computation parties are sorted circularly.

It is worthwhile to note that limitations such as “first”, “second”, and “third” in this disclosure have no limitation on aspects such as a size, a sequence, and a quantity, but are merely used to distinguish between names, for example, “first data component”, “second data component”, “third data component”, etc. are used to distinguish between data components by name.

According to some embodiments of another aspect, a computer-readable storage medium is further provided. The computer-readable storage medium stores a computer program, and when the computer program is executed on a computer, the computer is enabled to perform the method described with reference to FIG. 2, FIG. 3, or FIG. 6.

According to some embodiments of still another aspect, a computing device is further provided, including a memory and a processor. The memory stores executable code, and when the processor executes the executable code, the method described with reference to FIG. 2, FIG. 3, or FIG. 6 is implemented.

With development of time and technology, a computer-readable storage medium has a broader meaning. A propagation path of a computer program is not limited to a tangible medium, can be directly downloaded from a network, etc. Any combination of one or more computer-readable storage media can be used. The computer-readable storage medium can be, by way of example rather than limitation, an electrical, magnetic, optical, electromagnetic, infrared, or semiconductor system, apparatus, or device, or any combination thereof. More specific examples (a non-exhaustive list) of the computer-readable storage medium include the following: an electrical connection with one or more leads, a portable computer disk, a hard disk, a random access memory (RAM), a read-only memory (ROM), an erasable programmable read-only memory (an EPROM or a flash memory), an optical fiber, a portable compact disk read-only memory (CD-ROM), an optical storage component, a magnetic storage device, or any suitable combination thereof. In this specification, the computer-readable storage medium can be any tangible medium that includes or stores a program, and the program can be used by or in combination with an instruction execution system, apparatus, or component.

The processor can include one or more single-core processors or a multi-core processor. The processor can include any combination of a general-purpose processor or a dedicated processor (for example, an image processor, an application processor, or a baseband processor).

In some embodiments, at least one of the processors can be packaged with logic of one or more controllers for system control logic. In some embodiments, at least one of the processors can be packaged with logic of one or more controllers for system control logic, to form a system in package. In some embodiments, at least one of the processors and logic of one or more controllers for system control logic can be integrated on the same die. In some embodiments, at least one of the processors and logic of one or more controllers for system control logic can be integrated on the same die, to form a system on a chip.

Computer program code for performing an operation of this specification can be written in one or more program design languages or a combination thereof. The program design language includes an object-oriented program design language, for example, Java, Smalltalk, and C++, and further includes a conventional procedural program design language, for example, a “C” language, or a similar program design language. The program code can be entirely executed on a user computer, or can be partially executed on a user computer as an independent software package, or can be partially executed on a user computer and partially executed on a remote computer, or can be entirely executed on a remote computer or server. When the remote computer is used, the remote computer can be connected to the user computer over any type of network, including a local area network (LAN) or a wide area network (WAN), or can be connected to an external computer (for example, connected by using an Internet service provider over the Internet).

Embodiments of this specification are all described in a progressive manner. For same or similar parts in the embodiments, mutual references can be made to the embodiments. Each embodiment focuses on a difference from other embodiments. In particular, the apparatus embodiment is basically similar to the method embodiment, and therefore is described briefly. For related parts, references can be made to related descriptions in the method embodiment.

A person skilled in the art should be aware that, in the above-mentioned one or more examples, functions described in this application can be implemented by hardware, software, firmware, or any combination thereof. When being implemented by software, these functions can be stored in a computer-readable medium or transmitted as one or more instructions or codes in the computer-readable medium.

The specific implementations mentioned above provide further detailed explanations of the objectives, technical solutions, and beneficial effects of this application. It should be understood that the previously mentioned descriptions are merely specific implementations of this application and are not intended to limit the protection scope of this application. Any modifications, equivalent replacements, improvements, etc. made on the basis of the technical solutions of this application shall all fall within the protection scope of this application.

What is claimed is:

1. A computer-implemented method for data processing by a system comprising a data provider and N secure multi-party computation (MPC) computation parties, wherein N is an integer greater than 3, and the method comprises:
obtaining, by each of the N MPC computation parties, a first data component from a data message sent by the data provider, wherein the first data component is a part of a plurality of data components obtained after the data provider splits private data, and the first data component is a logical component; and
converting the first data component from the logical component to an arithmetic component, to obtain a second data component, so as to perform MPC processing.

2. The computer-implemented method according to claim 1, wherein:
the N MPC computation parties comprise a first MPC computation party, a second MPC computation party, and a third MPC computation party; and
converting the logical component into the arithmetic component comprises:
performing, by each of the N MPC computation parties, zero-sharing processing, to obtain a third data component, wherein the third data component is an arithmetic component;
performing, by the first MPC computation party, a first conversion and a second conversion on an arithmetic value by using a locally held logical component, to obtain two options, wherein the two options are arithmetic components;
performing, by the first MPC computation party, an oblivious transfer to the third MPC computation party by using the two options; and
performing, by each of the N MPC computation parties, arithmetic sharing processing by using a locally obtained arithmetic component as to-be-shared data, to obtain the second data component.

3. The computer-implemented method according to claim 2, wherein the zero-sharing processing comprises:
generating, by each of the N MPC computation parties, a first derived value by using a locally held first zero-sharing key;
generating a second derived value by using a locally held second zero-sharing key; and
obtaining the third data component based on a difference between the first derived value and the second derived value.

4. The computer-implemented method according to claim 2, wherein:
the logical component comprises a first logical component and a second logical component;
the performing, by the first MPC computation party, a first conversion and a second conversion on an arithmetic value by using a locally held logical component comprises:
generating, by the first MPC computation party, a random value by using an interaction key; and
performing the first conversion and the second conversion by using the first logical component and the second logical component that are locally held, the random value, and a quantity of decimal places of a fixed-point number used for the MPC processing, to obtain the two options; and
the method further comprises: generating, by the second MPC computation party, the random value by using the interaction key.

5. The computer-implemented method according to claim 4, wherein the first conversion and the second conversion are respectively performed based on the following formulas, to obtain options m0 and m1:
m0=(0\hat{ }u1\hat{ }u2)×(1<<B)−rnd; and
m1=(1\hat{ }u1\hat{ }u2)×(1<<B)−rnd, wherein
\hat{ } is an exclusive OR operator;
<<is a left-moving operator;
u1 and u2 are respectively the first logical component and the second logical component;
rnd is the random value; and
B is the quantity of decimal places of the fixed-point number used for the MPC processing.

6. The computer-implemented method according to claim 2, wherein the performing, by each of the N MPC computation parties, arithmetic sharing processing by using a locally obtained arithmetic component, to obtain the second data component comprises:
sharing, by each of the N MPC computation parties, local to-be-shared data with a next MPC computation party after encrypting the local to-be-shared data, and receiving and decrypting data shared by a previous MPC computation party to obtain decrypted data;
combining the decrypted data and the local to-be-shared data, to obtain the second data component; and
performing, by each of the N MPC computation parties, the sharing processing in a cyclic order.

7. A computer-implemented method for data processing by a system comprising a data provider and N MPC computation parties, wherein N is an integer greater than 3, and the method comprises:
splitting, by the data provider, data into a plurality of data components; and
distributing, by the data provider, the plurality of data components to the N MPC computation parties by using a data message, wherein each MPC computation party receives a part of the plurality of data components, and uses the part of data components as a first data component, wherein the first data component is a logical component.

8. The computer-implemented method according to claim 7, wherein the plurality of data components are N data components; and
the distributing the plurality of data components to the N MPC computation parties by using a data message comprises: sending two data components to each of the N MPC computation parties, wherein a 1^{st} data component sent to an MPC computation party is the same as a 2^{nd} data component sent to a previous MPC computation party of the MPC computation party; and
the MPC computation parties are sorted circularly.

9. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations for data processing by a system comprising a data provider and N secure multi-party computation (MPC) computation parties, wherein Nis an integer greater than 3, and the one or more operations comprise:
obtaining, by each of the N MPC computation parties, a first data component from a data message sent by the data provider, wherein the first data component is a part of a plurality of data components obtained after the data provider splits private data, and the first data component is a logical component; and
converting the first data component from the logical component to an arithmetic component, to obtain a second data component, so as to perform MPC processing.

10. The computer-implemented system according to claim 9, wherein:
the N MPC computation parties comprise a first MPC computation party, a second MPC computation party, and a third MPC computation party; and
converting the logical component into the arithmetic component comprises:
performing, by each of the N MPC computation parties, zero-sharing processing, to obtain a third data component, wherein the third data component is an arithmetic component;
performing, by the first MPC computation party, a first conversion and a second conversion on an arithmetic value by using a locally held logical component, to obtain two options, wherein the two options are arithmetic components;
performing, by the first MPC computation party, an oblivious transfer to the third MPC computation party by using the two options; and
performing, by each of the N MPC computation parties, arithmetic sharing processing by using a locally obtained arithmetic component as to-be-shared data, to obtain the second data component.

11. The computer-implemented system according to claim 10, wherein the zero-sharing processing comprises:
generating, by each of the N MPC computation parties, a first derived value by using a locally held first zero-sharing key;
generating a second derived value by using a locally held second zero-sharing key; and
obtaining the third data component based on a difference between the first derived value and the second derived value.

12. The computer-implemented system according to claim 10, wherein:
the logical component comprises a first logical component and a second logical component;
the performing, by the first MPC computation party, a first conversion and a second conversion on an arithmetic value by using a locally held logical component comprises:
generating, by the first MPC computation party, a random value by using an interaction key; and
performing the first conversion and the second conversion by using the first logical component and the second logical component that are locally held, the random value, and a quantity of decimal places of a fixed-point number used for the MPC processing, to obtain the two options; and
the one or more operations further comprise: generating, by the second MPC computation party, the random value by using the interaction key.

13. The computer-implemented system according to claim 12, wherein the first conversion and the second conversion are respectively performed based on the following formulas, to obtain options m0 and m1:
m0=(0\hat{ }u1\hat{ }u2)×(1<<B)−rnd; and
m1=(1\hat{ }u1\hat{ }u2)×(1<<B)−rnd, wherein
\hat{ } is an exclusive OR operator;
<<is a left-moving operator;
u1 and u2 are respectively the first logical component and the second logical component;
rnd is the random value; and
B is the quantity of decimal places of the fixed-point number used for the MPC processing.

14. The computer-implemented system according to claim 10, wherein the performing, by each of the N MPC computation parties, arithmetic sharing processing by using a locally obtained arithmetic component, to obtain the second data component comprises:
sharing, by each of the N MPC computation parties, local to-be-shared data with a next MPC computation party after encrypting the local to-be-shared data, and receiving and decrypting data shared by a previous MPC computation party to obtain decrypted data;
combining the decrypted data and the local to-be-shared data, to obtain the second data component; and
performing, by each of the N MPC computation parties, the sharing processing in a cyclic order.

15. The computer-implemented system according to claim 9, and the one or more operations comprise:
splitting, by the data provider, data into a plurality of data components; and
distributing, by the data provider, the plurality of data components to the N MPC computation parties by using a data message.

16. The computer-implemented system according to claim 15, wherein the plurality of data components are N data components; and
the distributing the plurality of data components to the N MPC computation parties by using a data message comprises: sending two data components to each of the N MPC computation parties, wherein a 1^{st} data component sent to an MPC computation party is the same as a 2^{nd} data component sent to a previous MPC computation party of the MPC computation party; and
the MPC computation parties are sorted circularly.
